(19) United States
(12) Patent Application Publication
(10) Pub. No.: US 2022/0211060 A1
(43) Pub. Date: Jul. 7, 2022

(54) PROCESS FOR DEMINERALIZING A MILK PROTEIN COMPOSITION, AND MILK PROTEIN COMPOSITION OBTAINABLE BY SAID PROCESS

(71) Applicant: EURODIA INDUSTRIE, PERTUIS (FR)

(72) Inventors: Anne GONIN, LE PUY STE REPARADE (FR); Florence LUTIN, ANTONY (FR); Denis LARGETEAU, MAUREPAS (FR)

(21) Appl. No.: 17/602,023

(22) PCT Filed: Apr. 2, 2020
(86) PCT No.: PCT/EP2020/059378

§ 371 Date: Oct. 7, 2021

(30) Foreign Application Priority Data
Apr. 12, 2019 (FR) FR1903955
Mar. 25, 2020 (FR) FR2002936

(51) Int. Cl. A23C 9/144; A23C 9/142; B01D 61/52; B01D 61/48

(52) U.S. Cl. CPC A23C 9/144; B01D 61/48; B01D 61/52; A23C 9/1425

(57) ABSTRACT

A process for manufacturing a demineralized milk protein composition, including a step (ii) of electrodialysis of a milk protein composition on an electrodialyzer, the unit cells of which have three compartments, and configured to substitute at least one cation by at least one hydrogen ion H+ in the milk protein composition to obtain an at least partially demineralized and acidified milk protein composition; a step (iii) of electrodialysis of the milk protein composition obtained in step (ii) on an electrodialyzer, the unit cells of which have three compartments, and configured so as to substitute at least one anion by at least one hydroxyl ion OH− in the milk protein composition.

### TECHNICAL FIELD

The present disclosure relates to a process for demineralizing a milk protein composition, and to the milk protein composition obtainable by this process, in particular a demineralized whey.

### BACKGROUND

A milk protein composition may be whey. Whey is the liquid part resulting from the coagulation of milk. Two types of whey can be distinguished: those resulting from the manufacture in an acid medium of caseins or fresh cheeses (acid whey); and those resulting from the manufacture of caseins using rennet and pressed cooked or semi-cooked cheeses (sweet whey).

Whey primarily includes water, lactose, proteins, in particular serum proteins, and minerals. Whey can be valorized by isolating both the lactose and the proteins.

Whey proteins can also be valorized as an ingredient in the manufacture of infant formula. Demineralized whey, in particular lactose, can be used in the manufacture of confectionery, cakes and ice creams, prepared dishes, pastries, etc.

Whey can be demineralized by undergoing a nanofiltration step, followed by electrodialysis and/or passage over cation- and anion-exchange resins to achieve demineralization rates of 70 to 90%, indeed higher.

However, ion-exchange resins generate large volumes of saline regeneration effluent that are difficult and costly to treat.

At the same time, consumers are increasingly looking for ingredients from the food processing industry that preserve their initial natural properties and, therefore, are not modified and/or denatured, or in any case as little as possible. In addition, processes for demineralizing milk products that limit or even eliminate the presence of exogenous mineral species are also sought. In fact, ion-exchange resins work by exchanging mineral species in the composition to be treated against exogenous mineral species. However, eliminating one or more passages on ion-exchange resins complicates the production of demineralized milk protein compositions at high levels, for example demineralized to 70%, 80% or 90%. As the demineralization is transferred to other treatment systems, there is a risk that the membranes of these systems will clog more quickly because of the high mineral load.

U.S. Pat. No. 4,971,701A describes a process for demineralizing whey comprising the simultaneous extraction of positively- and negatively-charged ions via an electrolysis technique. This process should not be confused with a three-compartment electrodialysis configured to allow substitution of cations, or anions, and not simultaneous extraction of cations and anions.

The present disclosure thus aims to propose a process for demineralizing a milk protein composition without using ion-exchange resins (anionic and/or cationic).

The present disclosure also aims to propose a process for demineralizing a milk protein composition that limits, or even eliminates, the introduction of exogenous mineral compounds into the milk protein composition.

### SUMMARY

The present disclosure overcomes the above-mentioned problems in that it has as its subject matter, according to a first aspect, a process for manufacturing a demineralized milk protein composition, characterized in that it comprises the following steps:

(i)—providing a milk protein composition
(ii)—electrodialysis of the milk protein composition on an electrodialyzer, the unit cells of which have three compartments, and configured to substitute at least one cation by at least one hydrogen ion H⁺ in the milk protein composition to obtain an at least partially demineralized and acidified milk protein composition;
(iii)—electrodialysis of the milk protein composition obtained in step (ii) on an electrodialyzer, the unit cells of which have three compartments, and configured to substitute at least one anion by at least one hydroxyl ion OH⁻ in the milk protein composition;
(iv) obtaining the demineralized milk protein composition.

In general, during electrodialysis, dissolved ionized mineral or organic species, such as salts, acids or bases, are transported through ionic membranes under the action of an electric current. An electrodialysis unit may comprise cationic (cation-permeable) membranes MEC and/or anionic (anion-permeable) membranes MEA arranged in parallel and alternating fashion. Under the action of the electric field applied by means of an anode and a cathode, the MECs block anions and allow cations to pass, while the MEAs block cations and allow anions to pass. Concentration compartments (concentrates) and desalination compartments are thus created. This most-common type of electrodialysis is an electrodialysis in which the basic unit cell comprises two compartments. The unit cell corresponds to the smallest repetition pattern of the concentration and desalination operations (one compartment corresponding to one concentration or desalination). The solutions are renewed in the compartments by a circulation parallel to the plane of the membranes. The application of a current is provided by two electrodes parallel to the plane of the membranes and placed at the ends of the electrodialyzer.

Advantageously, and in a novel manner, in the present disclosure, the electrodialyzers have three compartments, and further allow ion substitutions. Thus, in addition to the desalination compartments (in which the ions disappear) and the concentration compartments (in which the ions accumulate), the electrodialyzers of steps ii) and iii) comprise conversion compartments, cationic in the case of step ii), and anionic in the case of step iii).

The milk protein composition (MPC) obtained in step ii) is thus depleted in cations, and thus acidified (with a drop in pH), whereas the milk protein composition obtained in step iii) is depleted in anions (with a rise in pH). Steps ii) and iii) combined thus make it possible to carry out a cationic demineralization followed by an anionic demineralization, these steps ii) and iii) thus corresponding, respectively, to a cationic substitution and an anionic substitution. The demineralization obtained is intensive, and may reach a demineralization rate greater than or equal to 70%, in particular greater than or equal to 75%, or 80% or even 85%, more particularly greater than or equal to 90%.

Advantageously, the process according to the disclosure does not generate regeneration effluents to be treated, does not consume, or consumes very little according to the different variants developed below, exogenous acid and base, and is therefore less polluting. This process can be described as eco-efficient.

The milk protein composition obtained in step ii) may have an acidic pH, in particular lower than or equal to the isoelectric point of the proteins (in particular serum proteins) of the MPC of step i), in particular lower than or equal to 6, in particular lower than or equal to 4.

This provision promotes the control of microbiological stability. In addition, the milk protein composition can then undergo heat treatment, under conditions of temperature and duration different from those applied in a non-acidic environment, which limits protein denaturation. The milk proteins are therefore advantageously less degraded.

Advantageously, raising the pH in step iii), in particular so as to be greater than or equal to the pKa of at least one organic acid of the treated composition, makes it possible to obtain the anionic form of the organic acid and thus to extract it through the anionic membranes in step iii).

The temperature of the milk protein composition in step ii) and/or step iii) may be less than or equal to 40° C., in particular greater than 0° C.

The milk protein composition after step iii), in particular in step iv), has a pH greater than or equal to 6, in particular greater than or equal to 6.2, more particularly less than or equal to 8.

Milk Protein Composition

The milk protein composition may be selected from: whey, such as sweet whey or acid whey or a mixture thereof; milk ultrafiltration permeate; milk microfiltration permeate; whey ultrafiltration retentate or permeate; milk microfiltration permeate ultrafiltration retentate or permeate; or a mixture thereof (List I).

The sweet whey and/or acid whey may be raw, i.e., it may have not undergone any operation to reduce its/their mineral load. The whey, mentioned without precision, may thus be raw or partially demineralized.

Sweet whey may be obtained by chemical treatment of the milk, in particular using rennet, to recover both the caseins and the sweet whey.

Acid whey may be obtained by acid treatment of the milk, in particular using lactic acid and/or hydrochloric acid, to recover both the caseins and the acid whey.

The raw or partially demineralized whey can be pre-concentrated, mechanically (for example by reverse osmosis or nanofiltration or a combination thereof) or thermally (for example by evaporation). The raw acidic whey and/or raw sweet whey and/or milk microfiltration permeate, has/have a dry extract greater than 0% and less than or equal to about 6% (±10%). The raw whey and/or the milk microfiltration permeate may undergo a concentration step, as defined above, in order to have a dry extract greater than or equal to about 18% (±10%) and less than or equal to about 22% (±10%).

The milk protein composition according to the disclosure is liquid when used. It can be obtained by reconstituting a liquid solution from powder(s) and/or liquid(s), in particular selected from List I above.

The milk protein composition in step i) may be partially demineralized. This arrangement would reduce the size of the three-compartment electrodialyzers in step ii) and/or step iii), i.e., the active membrane surface.

The demineralization rate of the milk protein composition in step i) may be greater than or equal to 30%, in particular greater than or equal to 40%, more in particular greater than or equal to 50%, more in particular greater than or equal to 60%, particularly less than or equal to 70%.

The demineralization rate of the milk protein composition obtained in step iv) may be greater than or equal to 70%, in particular greater than or equal to 85%, more particularly greater than or equal to 90% (DM90).

In an embodiment, the milk protein composition may have a dry extract by mass of greater than 1%, in particular greater than or equal to 5%, and less than or equal to 10%. For example, it may be a non-concentrated whey.

In another embodiment, the milk protein composition may have a dry extract by mass greater than or equal to 10%, and less than or equal to 30%; in particular greater than or equal to 15% and less than or equal to 25%. It may be, for example, a concentrated whey. The concentration of the dry matter of the whey can be carried out by reverse osmosis, nanofiltration or any other thermal concentration method.

In general, the milk protein composition may be derived from any dairy female.

The milk protein composition may be derived from a milk selected from: cow's milk, goat's milk, sheep's milk, donkey's milk, buffalo milk, mare's milk, or a mixture thereof, in particular selected from: cow's milk, goat's milk and sheep's milk or a mixture thereof, in particular it is cow's milk.

The protein composition comprises milk proteins, in particular serum proteins.

The whey comprises serum proteins and does not comprise caseins remaining in the bulk (coagulated) part during milk processing and/or in the milk microfiltration retentate.

The raw sweet whey may have one of the following properties, alone or in combination:
a pH comprised between 5.8 and 6.5;
the ratio of the mass of lactose to the mass of dry extract is greater than or equal to 70%, in particular greater than or equal to 74%;
the ratio of the mass of proteins to the mass of the dry extract is greater than or equal to 10%, in particular greater than or equal to 12%, in particular less than or equal to 30%;
the ratio of the mass of ash to the mass of dry matter is greater than or equal to 8%, in particular less than or equal to 10%; and
the ratio of the mass of organic acids to the mass of the dry extract is greater than or equal to 2%, in particular less than or equal to 5%.

The raw acid whey may have one of the following properties, alone or in combination:
a pH less than or equal to 5, in particular less than or equal to 4.5;
the ratio of the mass of the lactose to the mass of the dry extract is greater than or equal to 55%, in particular less than or equal to 65%, in the case of whey derived from the manufacture of cheeses in an acid medium;
the ratio of the mass of lactose to the mass of dry matter is greater than or equal to 70%, in particular less than or equal to 85%, in the case of whey derived from the manufacture of caseins in an acid medium;
the ratio of the mass of proteins to the mass of dry matter is greater than or equal to 4%, in particular less than or equal to 12%;
the ratio of the mass of ash to the mass of dry matter is greater than or equal to 10%, in particular less than or equal to 15%; and
the ratio of the mass of organic acids to the mass of the dry extract is greater than or equal to 10%, in particular less than or equal to 20%, in the case of whey derived from the manufacture of cheeses in a lactic acid medium;
the ratio of the mass of organic acids to the mass of dry matter is greater than or equal to 2%, in particular less than or equal to 5%, in the case of whey derived from the manufacture of caseins in an acid medium.

Demineralization includes the total or partial removal of the ash present in the milk protein composition, particularly the whey.

The ash content of the milk protein composition can be determined with the standardized method NF V04-28 Oct. 1989, entitled “Milk—Determination of ash—Reference method”.

In the present text, dry extract by mass is understood to mean the dry mass of the milk protein composition, obtained after evaporation of the water until a stable total dry mass is obtained based on the total mass of the milk protein composition, particularly at atmospheric pressure. The dry extract by mass can be determined with the standardized method ISO 6731: January 2011, “Milk, cream, and unsweetened condensed milk—Determination of dry matter (Reference method)”.

The milk protein composition (or MPC), in step i), may have a conductivity of greater than or equal to 1 mS/cm, in particular greater than or equal to 3 mS/cm.

The MPC, in step iv), may have an ash content of less than or equal to 2.5% and in particular less than or equal to 1.5% on dry basis.

The milk protein composition may comprise the following cations: calcium, magnesium, sodium, potassium, which are in particular the cations targeted by the demineralization process according to the disclosure.

The milk protein composition may comprise the following anions: chloride, phosphate, sulfate, lactate, acetate, and citrate, which are in particular the anions targeted by the demineralization process according to the disclosure.

In an embodiment, the monovalent cations and monovalent anions are at least partially extracted from the MPC in a preliminary demineralization step, prior to step i), comprising a nanofiltration or reverse osmosis step and a two-compartment electrodialysis step, in particular applied to the nanofiltration retentate.

In a variant, the manufacturing process comprises a step of treating (v) at least part of the salt(s), such as the sodium chloride salt and/or the potassium chloride salt (NaCl, KCl), selected from the following salts:
the salt(s) derived directly from the electrodialysis step ii),
the salt(s) derived indirectly from the electrodialysis step ii),
the salt(s) derived directly from the electrodialysis step iii),
the salt(s) derived indirectly from the electrodialysis step iii),
the salt(s) from a preliminary demineralization step carried out on the milk protein composition in step i),
a mixture of the latter,
   the treatment step (v) being configured to produce one or more acid(s) from the salt(s) on the one hand, such as hydrochloric acid and/or sulfuric acid, and one or more base(s) from the salt(s) on the other hand, such as sodium hydroxide and/or potassium hydroxide.

It is understood by the salt is derived directly from step ii) and/or iii) and/or i) that the latter has not undergone a step vi) or vii) defined below, in particular a nanofiltration step.

It is understood by the salt is derived indirectly from step ii) and/or iii) and/or i) that the latter has undergone a step vi) or vii) defined below, in particular a nanofiltration step.

The preliminary demineralization step includes a step of electrodialysis on a two-compartment electrodialyzer, in particular comprising permselective membranes, in particular anionic and/or cationic. In this case, the salts used in steps ii) and/or iii) are thus advantageously at least partly derived from the milk protein composition itself.

The salt(s) used in the process according to the disclosure may be selected from: a chloride of a monovalent cation; a chloride of a divalent cation; in particular sodium chloride, potassium chloride, and calcium chloride; a sulfate of a monovalent cation, a sulfate of a divalent cation; in particular sodium sulfate, potassium sulfate, and calcium sulfate; a phosphate of a monovalent cation, a phosphate of a divalent cation; in particular sodium phosphate, potassium phosphate, and calcium phosphate; and a mixture thereof.

Step ii) (in particular cationic substitution) may comprise circulating the milk protein composition between two cationic membranes, in particular the compartment in which the milk protein composition circulates is delimited between two cationic membranes.

Step iii) (in particular anionic substitution) may comprise circulating the milk protein composition between two anionic membranes, in particular the compartment in which the milk protein composition circulates is delimited between two anionic membranes.

In a variant, the treatment step (v) includes an electrodialysis step carried out on a bipolar membrane electrodialyzer.

A bipolar membrane is composed of a cation-exchange layer and an anion-exchange layer separated by a hydrophilic junction.

In a variant, the bipolar membrane electrodialyzer, in step (v), comprises unit cells with three compartments A, B and C, compartments A and B are supplied with water and a compartment C, arranged between compartments A and B, is supplied with one or more salt(s), in particular sodium chloride salt and/or potassium chloride salt (NaCl and/or KCl).

In an embodiment, the unit cells of the electrodialyzer in step v) each comprise a first compartment delimited between a bipolar membrane and an anionic membrane, a second compartment delimited between an anionic membrane and a cationic membrane, and a third compartment delimited between a cationic membrane and a bipolar membrane.

The first compartment and the third compartment may be supplied with water, and the second compartment, arranged between the first and third compartments, is supplied with salt(s).

Advantageously, step v), in particular the bipolar membrane electrodialysis step v), generates an acid, in particular hydrochloric acid and/or sulfuric acid, and a base, in particular sodium hydroxide and/or potassium hydroxide, from the flows of salt(s) derived from steps ii) and/or iii), in particular from their respective first or third compartments (depending on whether steps ii) and/or iii) use permselective membranes defined below).

This arrangement makes it possible to carry out the electrodialysis steps ii) and/or iii) with acid or basic salts from the milk protein composition itself. The process thus makes it possible to eliminate, or at least to reduce very significantly, the introduction of exogenous mineral compounds.

The salt(s), in particular the sodium chloride salt, may also originate, in part, from the preliminary demineralization step(s) applied to the milk protein composition in step i), in particular derived from a nanofiltration and/or electrodialysis (two compartment) step.

In a variant, at least part of the salt(s), in particular of hydrochloric acid and/or of sulfuric acid, obtained during the treatment step (v) is/are supplied to one of the three compartments of the electrodialyzer in step ii).

In a variant, at least part of the salt(s), in particular of sodium hydroxide and/or of potassium hydroxide, obtained during the treatment step (v), is/are supplied to one of the three compartments of the electrodialyzer in step iii).

In a variant, the electrodialysis step ii) produces a mixture comprising at least one chloride salt of a monovalent cation, such as a sodium chloride salt and/or a potassium chloride salt, and at least one chloride salt of a divalent cation, such as a calcium chloride (CaCl₂) salt, and the mixture undergoes a separation step (vi) of the chloride salt(s) of a monovalent cation, and the chloride salt(s) of a divalent cation, in particular a nanofiltration step.

In a variant, the process according to the disclosure comprises a step of electrodialysis of the at least partially demineralized and acidified milk protein composition (MPC1) obtained in step ii), and carried out before step iii), on an electrodialyzer comprising two-compartment unit cells.

The electrodialyzer comprises a plurality of cells, for example at least five cells.
In a first embodiment, the electrodialyzer comprises at least one unit cell comprising a first compartment delimited between a cationic membrane and an anionic membrane, and a second compartment delimited between an anionic membrane, in particular that of the first compartment, and a cationic membrane, in particular that of the first compartment. The first compartment may be supplied with the partially demineralized and acidified milk protein composition (MPC1) obtained in step ii). The second compartment may be supplied with water.

This step advantageously allows the extraction of both anions and cations in MPC1.

This intermediate electrodialysis step, in particular between ESC (ii) and ESA (iii), allows the size of the electrodialyzer (i.e., the number of cells) to be reduced in step iii).

This intermediate two-compartment electrodialysis step carried out between steps ii) and iii) also makes it possible to achieve a cation and anion removal rate of more than 90%.

The intermediate electrodialysis step on a two-compartment electrodialyzer may be carried out before or after the heat treatment step viii) described in the present text.

In a variant, the electrodialysis step iii) produces a mixture comprising at least one sodium salt of a monovalent anion, and at least one sodium salt of a divalent anion, in particular a sodium chloride (NaCl) salt and a sodium phosphate salt and this mixture undergoes a separation step (vii), in particular a nanofiltration step, of the sodium salt(s) of a monovalent anion and of the sodium salt(s) of a divalent anion.

These steps vi) and/or vii) make it possible to complete the bipolar membrane electrodialysis, in particular if steps ii) and iii) are carried out without permselective membranes, by avoiding the precipitation of divalent cation(s), in particular calcium and/or magnesium, on the membranes, in particular on the cationic membranes of the bipolar electrodialysis of step v).

In a variant, the salt of a monovalent cation, in particular the chloride salt of a monovalent cation, such as sodium chloride, collected at the conclusion of the separation step (vi) and/or the separation step (vii), is supplied to the electrodialysis step ii) and/or to the electrodialysis step iii).

This arrangement applies in particular when steps (ii) and (iii) are carried out with permselective membranes as defined below.

In a variant, the salt of a monovalent cation, in particular the chloride salt of a monovalent cation, such as sodium chloride, collected at the conclusion of the separation step (vi) and/or the separation step (vii) undergoes, at least in part, the treatment step (v).

This arrangement applies in particular when steps (ii) and (iii) are carried out without permselective membranes as defined below.

In a variant, the electrodialyzer in step ii) comprises at least one membrane permselective to monovalent cations.

Thus, the membrane permselective to monovalent cations (or to monovalent anions), is crossed only by monovalent cations (or by monovalent anions), and is not crossed by anions (or cations), and cations (or anions) having a valence greater than 1, in particular divalent.

In a variant, the three-compartment unit cells of the electrodialyzer in step ii) may comprise at least one unit cell comprising, and/or each of the unit cells may comprise:
a first compartment delimited between a membrane permselective to monovalent cations and a cationic membrane;
a second compartment delimited between two cationic membranes; and
a third compartment delimited between a cationic membrane and a membrane permselective to monovalent cations.

In another variant, the three-compartment unit cells of the electrodialyzer in step ii) may comprise at least one unit cell comprising, and/or each of the unit cells may comprise:
a first compartment delimited between an anionic membrane and a cationic membrane;
a second compartment delimited between two cationic membranes, and
a third compartment delimited between a cationic membrane and an anionic membrane.

Step (ii) of cationic substitution can thus be carried out using permselective membrane(s) or not.

In a sub-variant (of the variants of step ii) above), the first compartment is supplied with at least one acid salt, such as a hydrochloric acid salt, the second compartment is supplied with the milk protein composition of step i), and the third compartment is supplied with at least one chloride salt of a monovalent cation, such as sodium.

In a variant, the electrodialyzer in step iii) comprises at least one membrane permselective to monovalent anions.

Thus, the membrane permselective to monovalent anions is crossed only by monovalent anions, and is not crossed by cations and anions having a valence higher than 1, in particular divalent, or having a molecular mass higher than or equal to 90 (daltons, i.e., the sum of the atomic masses of the various atoms constituting the molecule).

In a variant, the three-compartment unit cells of the electrodialyzer in step iii) may comprise at least one unit cell comprising, and/or each of the unit cells may comprise:
a first compartment delimited between a membrane permselective to monovalent anions and an anionic membrane;
a second compartment delimited between two anionic membranes;
a third compartment delimited between an anionic membrane and a membrane permselective to monovalent anions.

In another variant, the three-compartment unit cells of the electrodialyzer in step iii) may comprise at least one unit cell comprising, and/or each of the unit cells may comprise:
a first compartment delimited between a cationic membrane and an anionic membrane;
a second compartment delimited between two anionic membranes, and
a third compartment delimited between an anionic membrane and a cationic membrane.

Step (iii) of anionic substitution can thus be carried out using permselective membrane(s) or not.

In a sub-variant (of the variants of step iii) above), the first compartment may be supplied with at least one basic salt, such as a sodium hydroxide salt, the second compartment is supplied with the partially demineralized and acidified milk protein composition obtained in step ii), and the third compartment may be supplied with at least one chloride salt of a monovalent cation, such as sodium.

In a variant, the process comprises a heat treatment step (viii), performed after step (ii) and before step (iii).

In this step (viii), the milk protein composition may be at a temperature greater than or equal to 70° C. and less than or equal to 110° C., for a time greater than or equal to 5 seconds and less than or equal to 10 minutes.

The acidic medium of the milk protein composition promotes the elimination of germs, including those that are more difficult to destroy, such as spore germs.

In a variant, the milk protein composition in step i) is whey, in particular derived from organic farming.

In a variant, the milk protein composition in step i) is partially demineralized whey, in particular having undergone at least one step selected from: an electrodialysis step, a nanofiltration step, a reverse osmosis step, an evaporation step, and a combination thereof.

These steps also concentrate the MPC, i.e., increase its dry extract by mass.

The subject matter of the present disclosure, according to a second aspect, relates to a demineralized milk protein composition obtainable by the manufacturing process according to any of the embodiment variants defined above with reference to the first aspect of the disclosure.

### BRIEF DESCRIPTION OF THE DRAWINGS

FIG. 1 schematically represents the various steps of a first example of a process for manufacturing a demineralized milk protein composition;

FIG. 2 schematically represents an example of the treatment step v) according to the disclosure, in particular a unit cell of the bipolar membrane electrodialyzer implemented in the first and second example processes shown in FIGS. 1 and 3; and

FIG. 3 schematically represents the various steps of a second example of a process for manufacturing a demineralized milk protein composition.

### DETAILED DESCRIPTION

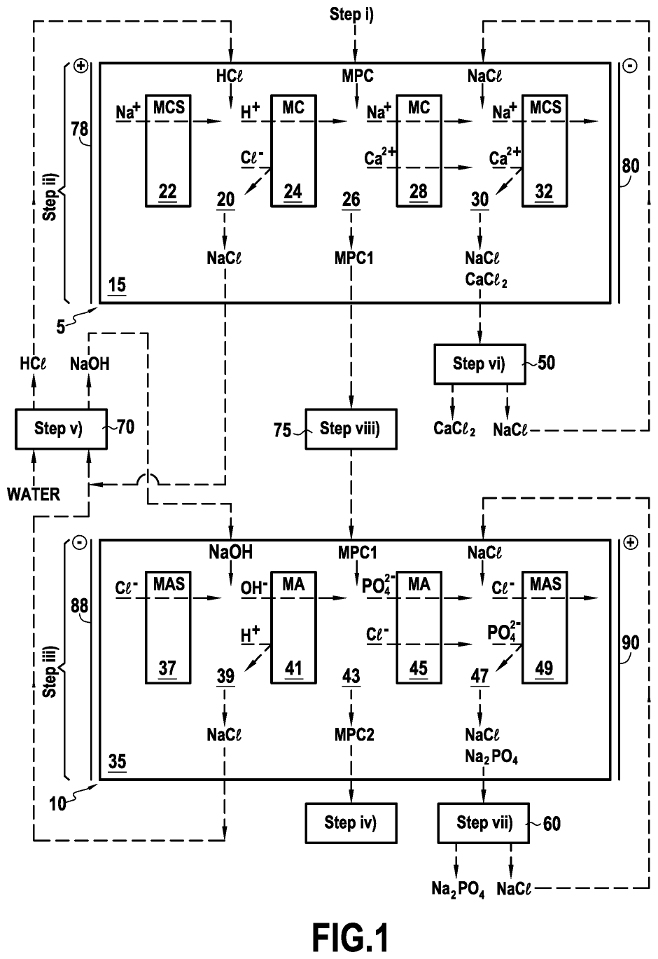

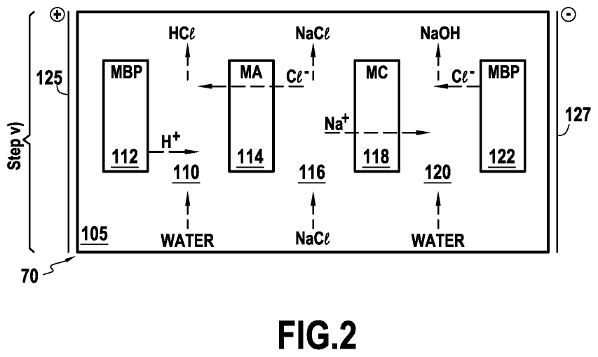

The first example of a process for manufacturing a demineralized milk protein composition represented in FIG. 1 comprises two electrodialyzers 5 and 10 whose unit cells 15 and 35 have three compartments. A single unit cell 15 of the electrodialyzer 5 is shown in FIG. 1. This unit cell 15 comprises a first compartment 20 delimited between a cationic permselective membrane 22 and a cationic membrane 24, a second compartment 26 delimited between the cationic membrane 24 and the cationic membrane 28, and a third compartment 30 delimited between the cationic membrane 28 and the cationic permselective membrane 32. A single unit cell 35 of the electrodialyzer 10 is shown in FIG. 1. This unit cell 35 comprises a first compartment 39 delimited between an anionic permselective membrane 37 and an anionic membrane 41, a second compartment 43 delimited between the anionic membrane 41 and an anionic membrane 45, and finally a third compartment 47 delimited between the anionic membrane 45 and the anionic permselective membrane 49. The cationic permselective membranes 22 and 32 can only be crossed by monovalent cations, and the permselective membranes 37 and 49 can only be crossed by monovalent anions. The electrodialyzers 5 and 10 each comprise a cathode (80, 88) and an anode (78, 90) generating a current through the conductive solutions passing through the compartments of the unit cells 15 and 35. The process also comprises a first nanofiltration device 50 for performing step vi), a second nanofiltration device 60 for performing step vii), and a three-compartment bipolar membrane electrodialyzer 70, detailed in FIG. 2, for performing step v). This first example process also comprises a heat treatment unit 75 for performing the heat treatment step viii).

In operation, a milk protein composition MPC, in particular whey demineralized to at least 50%, is supplied in a step i) and then supplied to the second compartment 26 of the electrodialyzer 5. At the same time, acidified salt, in particular a hydrochloric acid solution, is supplied to the first compartment 20, and brine, in particular a sodium chloride salt, is supplied to the third compartment 30. The H⁺ ions cross the cationic membrane 24 and are replaced by Nat ions coming from the third compartment 30 and thus passing through the permselective membrane 32 or 22 under the effect of the electric field. The monovalent and/or divalent cations, in particular Na⁺ ions and Ca²⁺ ions, cross the cationic membrane 28, under the effect of the electric field, in the direction of the cathode 80, and are substituted by H⁺ ions coming from the first compartment 20. The milk protein composition obtained MPC1 in step i) is thus partially demineralized, the cations having been substituted by H⁺, and acidified. The pH of MPC1 is less than or equal to 4. The third compartment 30 comprises a mixture of chloride salts, in particular a calcium chloride salt (CaCl₂) and a sodium chloride salt (NaCl), derived from the milk protein composition MPC. The monovalent ions (e.g., Na⁺; K⁺) thus cross the cationic permselective membrane 22 or 32 and supply the first compartment 20 while the divalent ions (e.g., Ca²⁺) remain in the third compartment 30.

The acidified milk protein composition MPC1 undergoes a heat treatment in step viii), (90° C., for a few minutes) to improve its bacteriological stability. Advantageously, as the composition MPC1 is acidified, the heat treatment conditions can be more intense than usual and defined so that the proteins are not altered.

The mixture of salts derived from the third compartment 30 may undergo a nanofiltration step vi) on the nanofiltration unit 50 in order to increase the purity of the sodium chloride salt derived from the third compartment 30 by retention of divalent salts, such as calcium chloride CaCl₂. The purified sodium chloride salt is thus supplied to the third compartment 30.

The composition MPC1, in particular pasteurized, undergoes a second electrodialysis step iii) on the electrodialyzer 10. The first compartment 39 is supplied with a basic salt, such as sodium hydroxide, from step v). The mobility of the OH⁻ ions being greater than the mobility of the Cl⁻ ions, the OH⁻ ions cross the anionic membrane 41, and are replaced by Cl⁻ ions coming from the first compartment 39 and having crossed an anionic permselective membrane 49 or 37 under the effect of the electric field. In the second compartment 43 supplied with the heat-treated and acidified composition MPC1, the residual anions (chlorides, sulfates, phosphates)⁻ cross the anionic membrane 45 under the effect of the electric field in the direction of the anode 90, and are substituted by OH⁻ ions from the first compartment 39. The composition MPC2 obtained in step iv) is thus demineralized and deacidified. In the third compartment 47, the mixture of sodium chloride and potassium chloride salts (NaCl, KCl) and phosphate salts are derived from MPC1. The chloride ions cross the anionic selective membrane 49 and supply the first compartment 39 while the divalent ions, in particular phosphate ions, are blocked in the third compartment 47 by the anionic permselective membrane 49.

The salts derived from the third compartment 47 may undergo a nanofiltration step vii) to increase the purity of the sodium chloride salt derived from the third compartment 47 by retention of phosphate ions.

This first example process also comprises a step v) of treating the sodium chloride salt on a three-compartment bipolar membrane electrodialysis unit 70 allowing regeneration of the acid, mainly HCl, and the base, mainly sodium hydroxide, from the NaCl flows derived from the first compartments 20 and 39 of the cationic and anionic electrodialysis steps ii) and iii), and optionally from the NaCl derived from the pre-demineralization steps carried out upstream on the composition MPC of step i), and/or from food-grade NaCl. The pre-demineralization steps may include a nanofiltration step followed by a two-compartment electrodialysis step applied to the nanofiltration retentate. With the exception of the salt used at the start of step v), the acidic and basic salts used for the implementation of the electrodialysis steps ii) and iii) are derived from the milk protein composition MPC1, which avoids the introduction of exogenous mineral compounds.

FIG. 2 shows the electrodialyzer 70 and a unit cell 105 thereof comprising a first compartment 110 delimited between a bipolar membrane 112 and an anionic membrane 114, a second compartment 116 delimited between the anionic membrane 114 and a cationic membrane 118, and a third compartment 120 delimited between the cationic membrane 118 and a bipolar membrane 122. The salt, in particular sodium or potassium chloride, is supplied to the second compartment 116. The chloride ions cross the anionic membrane 114 under the effect of the electric field toward the anode 125 while the Na⁺, K⁺ ions cross the cationic membrane under the effect of the electric field to the cathode 127. This step v) allows regeneration of the acidic and basic salts, in particular hydrochloric acid and sodium hydroxide, which are then supplied for the acidic salt to the first compartment of the unit cell 15 of step ii), and for the basic salt to the first compartment of the unit cell 35 of step iii).

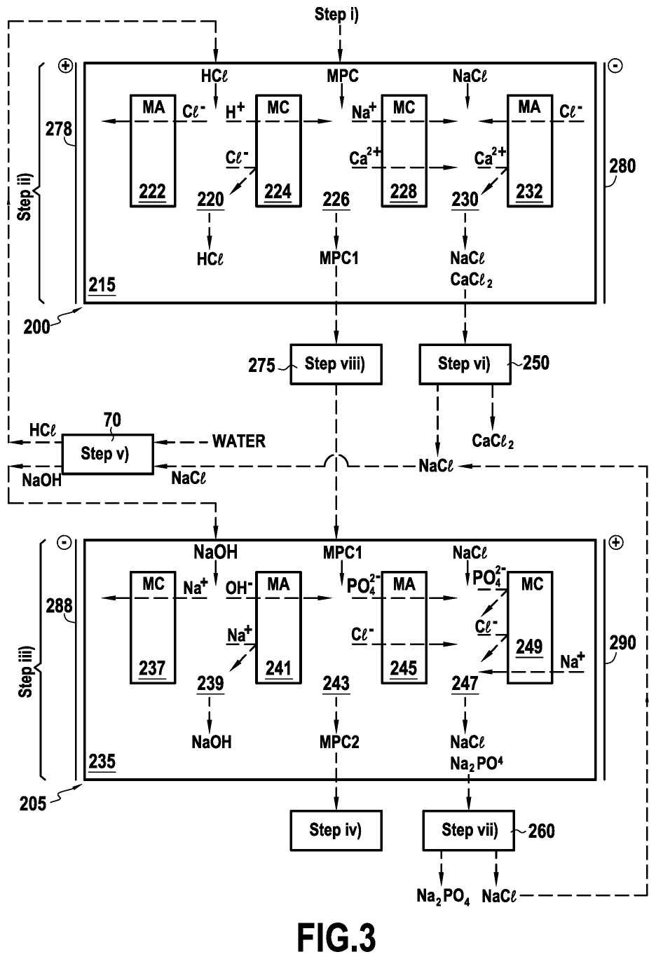

The second example process for manufacturing a demineralized milk protein composition shown in FIG. 3 comprises two electrodialyzers 200 and 205 whose unit cells (215, 235) have three compartments. A single unit cell 215 of the electrodialyzer 200 is shown in FIG. 3. This unit cell 215 comprises a first compartment 220 delimited between an anionic membrane 222 and a cationic membrane 224, a second compartment 226 delimited between the cationic membrane 224 and the cationic membrane 228, and a third compartment 230 delimited between the cationic membrane 228 and the anionic membrane 232. A single unit cell 235 of the electrodialyzer 205 is also shown in FIG. 3. This unit cell 235 comprises a first compartment 239 delimited between a cationic membrane 237 and an anionic membrane 241, a second compartment 243 delimited between the anionic membrane 241 and an anionic membrane 245, and a third compartment 247 delimited between the anionic membrane 245 and the cationic membrane 249. The electrodialyzers 200 and 205 each comprise an anode (278, 290) and a cathode (280, 288) generating a current through the conductive solutions passing through the compartments of the unit cells 215 and 235. The process also comprises a first nanofiltration device 250 for performing step vi), a second nanofiltration device 260 for performing step vii), and a three-compartment bipolar membrane electrodialyzer 70, detailed in FIG. 2, for performing step v). In addition, the process comprises a heat treatment unit 275 for performing the heat treatment step viii).

In operation, a milk protein composition MPC, in particular whey demineralized to at least 50%, is supplied to the second compartment 226 of the electrodialyzer 200. At the same time, acidified salt, in particular a hydrochloric acid solution, is supplied to the first compartment 220, and brine, in particular a sodium chloride salt and a potassium chloride salt, is supplied to the third compartment 230. Only H⁺ ions cross the cationic membrane 224 to the second compartment 226 toward the cathode 280, and chloride ions cross the anionic membrane 232 to the third compartment 230 toward the anode 278. In the second compartment 226, monovalent or divalent cations, such as Na⁺ and Ca²⁺, cross the cationic membrane 228 under the effect of the electric field toward the cathode 280, and are substituted by H⁺ ions from the first compartment 220. The milk protein composition obtained MPC1 in step ii) is thus partially demineralized, the cations having been substituted by H⁺ ions, and acidified. The pH of MPC1 is less than or equal to 4. The third compartment 230 comprises a mixture of CaCl₂ and NaCl derived from the milk protein composition MPC. Chloride ions from the first compartment 220 cross the anionic membrane 222 or 232 and supply the third compartment 230.

The acidified milk protein composition MPC1 undergoes a heat treatment in step viii), in particular a heat-treatment step (90° C., for a few minutes) in order to improve its bacteriological stability. Advantageously, since the composition MPC1 is acidified, the conditions of the heat treatment can be defined so that the proteins are not altered.

The salt mixture derived from the third compartment 230 may undergo a nanofiltration step vi) on the nanofiltration unit 250 to increase the purity of the sodium chloride salt derived from the third compartment 230 by removing divalent salts, such as calcium chloride CaCl₂. This step may optionally be followed by a chelating resin run to achieve the 3-5 ppm input specification of step v).

The composition MPC1, in particular heat-treated, undergoes a second electrodialysis step iii) on the electrodialyzer 205. The first compartment 239 is supplied with a basic salt, such as sodium hydroxide, from step v). OH⁻ ions cross the anionic membrane 241 toward the second compartment 243, and Na⁺ ions cross the cationic membrane 249 toward the third compartment 247. In the second compartment 243, residual anions from the acidified, heat-treated MPC1, such as chlorides and phosphates, cross the anionic membrane 245 under the effect of the electric field toward the anode 290, and are substituted by hydroxyl ions OFF, from the first compartment 239. The composition obtained MPC2 is demineralized and deacidified in step iv). In the third compartment 247, the mixture of chloride salts of monovalent cations, including potassium and sodium chloride salts, phosphate salts, and sulfate salts, are derived from MPC1. The monovalent or divalent anions, such as chlorides, phosphates, sulfates, cross the anionic membrane 245 and supply the third compartment 247.

The salts from the third compartment 247 may undergo a nanofiltration step vii) to increase the purity of the sodium chloride salt derived from the third compartment 247 by extracting the phosphate ions.

This second example process also comprises a step v) of treating the sodium chloride salt on a three-compartment bipolar membrane electrodialysis unit 70 allowing regeneration of the acid, mainly HCl, and the base mainly sodium hydroxide, from the NaCl flows derived indirectly from the third compartments 230 and 247 of steps ii) and iii) of cationic and anionic electrodialysis since they have previously undergone the nanofiltration steps of steps vi) and vii). The NaCl flows may optionally come, mixed or not with those derived from steps ii) and iii), from the NaCl from the pre-demineralization steps carried out upstream on the composition MPC of step i), and/or from a food-grade NaCl. The pre-demineralization steps may include a nanofiltration step followed by a two-compartment electrodialysis step applied to the nanofiltration retentate. With the exception of the salts used at the start of steps ii) and iii), thanks to step v), the acidic and basic salts used for the implementation of electrodialysis steps ii) and iii) are derived from the milk protein composition MPC1, which avoids the introduction of exogenous mineral compounds.

The second example process differs from the first example in that steps ii) and iii) do not comprise permselective membranes, and that the NaCl flows treated by bipolar membrane electrodialysis are not derived directly from the electrodialyzers 200 and 205, but undergo an intermediate nanofiltration step corresponding to step vi) or vii).

The cationic substitution step ii) can be carried out either on the electrodialyzer 5 (FIG. 1) or 200 (FIG. 3).

The anionic substitution step iii) can be carried out either on the electrodialyzer 10 (FIG. 1) or 205 (FIG. 3).

For carrying out the tests described below, a milk protein composition, MPC, was made by preparing a dispersion of sweet whey powder (raw), at 16% dry mass in demineralized water. The dispersion is mechanically stirred until a homogeneous mixture is obtained. MPC thus presents the following parameters: mass rate in dry matter: 15.9% (powder mass/total mass); pH=5.95; initial conductivity: 10.95 mS/cm; ash content by mass: 8.1%; lactose content by mass: 73.5%; cation content by mass (in particular Na, NH₄, K, Ca, Mg): 3.79%; anion content by mass (in particular CI, NO₃, PO₄, SO₄): 3.64%; the various mass rates (except for that in dry matter) are calculated by relating the total mass of one or more compounds to the total mass of the dry matter.

1—Cationic Substitution on the Electrodialyzer 200 (FIG. 3)

The electrodialyzer 200 comprises, for example, from 5 to 15 cells 215. The first compartment 220 is supplied with an HCl solution having a conductivity greater than or equal to 100 mS/cm, in particular greater than or equal to 150 mS/cm. The second compartment 226 is supplied with MPC exemplified above. The third compartment is supplied with a NaCl solution having a conductivity less than or equal to 50 mS/cm, in particular less than or equal to 25 mS/cm, in this specific example less than or equal to 15 mS/cm. A current (I) greater than or equal to 1 ampere, in particular less than or equal to 2 amperes, is applied to the electrodialyzer 200, and the voltage may be left free. During electrodialysis ii), the conductivity of MPC decreases indicating its demineralization, and then it increases because the cations it comprises are substituted by H⁺ ions. The pH of MPC1 obtained is of the order of 1, and the conductivity of MPC1 is about 12 mS/cm. The conductivity of the acidic solution, i.e., HCl, at the outlet of the first compartment 220 is lowered by about 74%, and the conductivity of the brine, i.e., NaCl, obtained at the outlet of the third compartment 230, is increased by about 234%. The cation removal is about 84%.

2—Cationic Substitution on the Electrodialyzer 5 (FIG. 1)

The electrodialyzer 5 comprises, for example, from 5 to 15 cells 15. The first compartment 20 is supplied with an HCl solution having a conductivity greater than or equal to 100 mS/cm, in particular greater than or equal to 150 mS/cm. The second compartment 26 is supplied with MPC exemplified above. The third compartment is supplied with a NaCl solution having a conductivity less than or equal to 50 mS/cm, in particular less than or equal to 25 mS/cm, in this specific example less than or equal to 15 mS/cm. A current (I) greater than or equal to 1 ampere, in particular less than or equal to 2 amperes, is applied to the electrodialyzer 5, and the voltage may be left free. At the beginning of electrodialysis ii), the conductivity of MPC decreases, indicating its demineralization, and then it increases because the cations it comprises are substituted by H⁺ ions. In the acidic compartment 20, the conductivity decreases due to the depletion of H⁺ ions and the production of NaCl, which is less conductive. The cations extracted from MPC migrate into the brine compartment 30, which is enriched in multivalent cations more conductive than NaCl. The pH of MPC1 obtained is of the order of 1, and the conductivity of MPC1 is about 12 mS/cm. The conductivity of the acid solution at the outlet of the first compartment 220 is lowered by about 35%, and the conductivity of the brine obtained at the outlet of the third compartment 30 is increased by about 25%. The cation removal is about 82%.

For the implementation of step iii), MPC1 used may be either that from electrodialyzer 5 or 200 since the latter have identical performance in terms of cation removal rate.

3—Anionic Substitution on the Electrodialyzer 205 (FIG. 3)

The electrodialyzer 205 comprises, for example, from 5 to 15 cells 235. The first compartment 239 is supplied with a NaOH solution having a conductivity greater than or equal to 30 mS/cm, in particular greater than or equal to 50 mS/cm. The second compartment 243 is supplied with MPC1 obtained above. The third compartment 247 is supplied with a NaCl solution having a conductivity less than or equal to 50 mS/cm, in particular less than or equal to 25 mS/cm, in this specific example less than or equal to 15 mS/cm. A current (I) greater than or equal to 1 ampere, in particular less than or equal to 2 amperes, is applied to the electrodialyzer 205, and the voltage may be left free. During electrodialysis iii), the conductivity of MPC1 decreases indicating its demineralization. The pH of MPC2 obtained is greater than 6, in this specific example of the order of 7.7, and the conductivity of MPC2 is about 1 mS/cm. The conductivity of the basic solution, i.e., NaOH, at the outlet of the first compartment 239 is lowered by about 120%, and the conductivity of the brine obtained at the outlet of the third compartment 247 is increased by about 126%. The anion removal is about 98%. The conductivity reduction of MPC to arrive at MPC2 is 85%.

4—Anionic Substitution on the Electrodialyzer 10 (FIG. 1)

The electrodialyzer 10 comprises, for example, from 5 to 15 cells 35. The first compartment 39 is supplied with a NaOH solution having a conductivity greater than or equal to 30 mS/cm, in particular greater than or equal to 50 mS/cm, in this specific example greater than or equal to 80 mS/cm. The second compartment 43 is supplied with MPC1 obtained above. The third compartment 47 is supplied with a NaCl solution having a conductivity less than or equal to 50 mS/cm, in particular less than or equal to 25 mS/cm, in this specific example less than or equal to 15 mS/cm. A current (I) greater than or equal to 1 ampere, in particular less than or equal to 2 amperes, is applied to the electrodialyzer 10, and the voltage may be left free. During electrodialysis iii), the conductivity of MPC1 decreases, indicating its demineralization. The pH of MPC2 obtained is greater than or equal to 6, of the order of 7, and the conductivity of MPC2 is about 2 mS/cm. The conductivity of the basic solution at the outlet of the first compartment 39 is lowered by about 21%, and the conductivity of the brine obtained at the outlet of the third compartment 47 is lowered by 25%. The anion removal is about 84%. The conductivity reduction of MPC to arrive at MPC2 is 77%.

Depending on the desired demineralization rate, it is possible starting from the above-exemplified MPC to reach a demineralization rate of 90%, with an ash rate lower than 1.5% on dry matter (DM), for example by combining the cationic substitution according to the above-exemplified point 1 or 2 with the anionic substitution according to the above-exemplified point 3.

It is also possible that the starting MPC is already partially demineralized, which makes it possible to combine the exemplified anionic substitution according to item 4 above with a cationic substitution according to the disclosure.

For the tests described below, a milk protein composition, MPC″, was made by preparing a dispersion of sweet whey powder (raw), at 17% dry mass in demineralized water. The dispersion is mechanically stirred until a homogeneous mixture is obtained. MPC″ thus has the following parameters: mass rate of dry matter: 17% (powder mass/total mass); pH=5; initial conductivity: 12 mS/cm; mass rate of ash: 8%; mass rate of lactose: 74%; mass rate of cations (in particular Na, NH₄, K, Ca, Mg): 5%; mass rate of anions (in particular CI, NO₃, PO₄, SO₄): 3%; the various mass rates (with the exception of that in dry matter) are calculated by relating the total mass of one or more compound(s) to the total mass of the dry matter.

5. Cationic Substitution on the Electrodialyzer 200 (ESC) (FIG. 3)

The electrodialyzer 200 comprises, for example, from 5 to 15 cells 215. The first compartment 220 is supplied with an HCl solution having a conductivity greater than or equal to 100 mS/cm, in particular greater than or equal to 150 mS/cm. The second compartment 226 is supplied with above-exemplified MPC″. The third compartment is supplied with a NaCl solution having a conductivity less than or equal to 50 mS/cm, in particular less than or equal to 25 mS/cm, in this specific example less than or equal to 15 mS/cm. A current (I) greater than or equal to 2 amperes, in particular less than or equal to 3 amperes, is applied to the electrodialyzer 200, and the voltage may be left free. During electrodialysis ii), the conductivity of MPC″ decreases indicating its demineralization, and then it increases because the cations it comprises are substituted by H⁺ ions. The pH of MPC1″ obtained is about 2, and the conductivity of MPC1″ is about 12 mS/cm. The conductivity of the acid solution, i.e., HCl, at the outlet of the first compartment 220 is lowered by about 53%, and the conductivity of the brine, i.e., NaCl, obtained at the outlet of the third compartment 230, is increased by about 292%. The cation removal (or substitution rate) is about 77%. The anion rate is substantially similar between MPC″ and MPC1″.

6. Conventional Two-Compartment Electrodialysis (ED) (Anionic Membrane/Cationic Membrane)

This electrodialyzer (not shown in the drawings) comprises, for example, from 5 to 15 cells. The first compartment is delimited between a cationic membrane and an anionic membrane, and the second compartment is delimited between an anionic membrane and a cationic membrane. The first compartment is supplied with above-described MPC1″ and the second compartment is supplied with a salt, in particular sodium chloride, having a conductivity greater than or equal to 5 ms/cm and less than or equal to 15 ms/cm. During the test, a voltage greater than or equal to 10 V and less than or equal to 20 V, in particular less than or equal to 15 V, is applied to the two-compartment electrodialyzer, and the current (I) is left free. During the test, the conductivity of MPC1″ decreases, indicating its demineralization. Part of the H⁺ ions are extracted in the brine compartment, hence the increase of the pH of MPC1″ (ESC+ED) at the outlet, in particular at a pH greater than or equal to 2.5, in particular greater than or equal to 3. The final conductivity of MPC1″(ESC+ED) is lowered, by about 90% compared with MPC, thanks to this conventional electrodialysis. The cation removal rate (Na, NH₄, K, Ca, Mg) in MPC1″ (ESC+ED) is greater than or equal to 90% (compared with MPC1″ obtained at the outlet of the cation substitution ED, FIG. 3). The anion removal rate (CI, NO₃, PO₄, SO₄) in MPC1″ (ESC+ED) is greater than or equal to about 80% (compared with MPC1″ obtained at the outlet of the cationic substitution ED, FIG. 3).

7. Anionic Substitution on the Electrodialyzer 205 (ESA) (FIG. 3)

The electrodialyzer 205 comprises, for example, from 5 to 10 cells 235. The first compartment 239 is supplied with a NaOH solution having a conductivity comprised between 20 and 35 mS/cm. The second compartment 243 is supplied with MPC1″ (ESC+ED) obtained above. The third compartment 247 is supplied with a NaCl solution having a conductivity less than or equal to 50 mS/cm, in particular less than or equal to 25 mS/cm, in this specific example, less than or equal to 15 mS/cm. A voltage greater than or equal to 10 V and less than or equal to 15 V is applied, and the current (I) may be left free. During electrodialysis iii), the conductivity of MPC1″ (ESC+ED) decreases, indicating its demineralization. The anions extracted from MPC1″ (ESC+ED) migrate to the third compartment containing the brine. The pH of MPC2″ obtained is higher than 4, in this specific example of the order of 5, and the conductivity of MPC2″ is lower than 1. The conductivity of the basic solution, i.e., NaOH, at the outlet of the first compartment 239 is lowered by more than 55%, and the conductivity of the brine at the outlet of the third compartment 247 is increased by more than 35%. The conductivity reduction from MPC″ to arrive at MPC2″ is greater than or equal to 95%. The final reduction rate (between MPC″ and MPC2″), for both anions and cations, is greater than or equal to 95%.

1. A process for manufacturing a demineralized milk protein composition, the process comprising the steps:
(i)—providing a milk protein composition;
(ii)—electrodialysis of the milk protein composition on an electrodialyzer, the unit cells of which have three compartments, and configured to substitute at least one cation by at least one hydrogen ion H⁺ in the milk protein composition to obtain an at least partially demineralized and acidified milk protein composition;
(iii)—electrodialysis of the milk protein composition obtained in step on an electrodialyzer, the unit cells of which have three compartments, and configured to substitute at least one anion by at least one hydroxyl ion OH⁻ in the milk protein composition;
(iv) obtaining the demineralized milk protein composition.

2. The process according to claim 1, comprising a step of treating (v) at least part of the salt(s) selected from the following salts:
the salt(s) derived directly from the electrodialysis step (ii),
the salt(s) derived indirectly from the electrodialysis step (ii),
the salt(s) derived directly from the electrodialysis step (iii),
the salt(s) derived indirectly from the electrodialysis step (iii),
the salt(s) from a preliminary demineralization step carried out on the milk protein composition in step (i),
a mixture of the latter,
wherein said treatment step (v) being configured to produce one or more acid(s) from the salt(s) on the one hand, and a base(s) from the salt(s) on the other hand.

3. The process according to claim 2, wherein the treatment step (v) includes an electrodialysis step carried out on a bipolar membrane electrodialyzer.

4. The process according to claim 3, wherein the bipolar membrane electrodialyzer, in step (v), comprises unit cells with three compartments A, B and C, the compartments A and B are supplied with water, and the compartment C, arranged between the compartments A and B, is supplied with one or more salt(s).

5. The process according to claim 2, wherein at least part of the salt(s) obtained during the treatment step (v), is supplied to one of the three compartments of the electrodialyzer in step (ii).

6. The process according to claim 2, wherein at least part of the salt(s) obtained during the treatment step (v), is supplied to one of the three compartments of the electrodialyzer in step (iii).

7. The process according to claim 1, comprising a step of electrodialysis of the at least partially demineralized and acidified milk protein composition obtained in step (ii), and carried out before step (iii), on an electrodialyzer comprising two-compartment unit cells.

8. The process according to claim 1, wherein the electrodialysis step (ii) produces a mixture comprising at least one chloride salt of a monovalent cation and at least one chloride salt of a divalent cation, and the mixture undergoes a separation step (vi) of the chloride salt(s) of a monovalent cation and the chloride salt(s) of a divalent cation.

9. The process according to claim 1, wherein the electrodialysis step (iii) produces a mixture comprising at least one sodium salt of a monovalent anion and at least one sodium salt of a divalent anion, and the mixture undergoes a separation step (vii) of the sodium salt(s) of a monovalent anion and of the sodium salt(s) of a divalent anion.

10. The process according to claim 8, wherein the salt of a monovalent cation collected at the conclusion of one or more of the separation step (vi) and the separation step (vii) is supplied to one or more of the electrodialysis step (ii) and the electrodialysis step (iii).

11. The process according to claim 8, wherein the salt of a monovalent cation collected at the conclusion of one or more of the separation step (vi) and the separation step (vii) undergoes, at least in part, the treatment step (v).

12. The process according to claim 1, wherein the electrodialyzer in step (ii) comprises at least one membrane permselective to monovalent cations.

13. The process according to claim 1, wherein the three-compartment unit cells of the electrodialyzer in step (ii) comprise at least one unit cell comprising:
a first compartment delimited between a membrane permselective to monovalent cations and a cationic membrane;
a second compartment delimited between two cationic membranes;
a third compartment delimited between a cationic membrane and a membrane permselective to monovalent cations.

14. The process according to claim 1, wherein the three-compartment unit cells of the electrodialyzer in step (ii) comprise at least one unit cell comprising:
a first compartment delimited between an anionic membrane and a cationic membrane;
a second compartment delimited between two cationic membranes; and
a third compartment delimited between a cationic membrane and an anionic membrane.

15. The process according to claim 13, wherein the first compartment is supplied with at least one acid salt, the second compartment is supplied with the milk protein composition of step (i), and the third compartment is supplied with at least one chloride salt of a monovalent cation.

16. The process according to claim 1, wherein the electrodialyzer in step (iii) comprises at least one membrane permselective to monovalent anions.

17. The process according to claim 1, wherein the three-compartment unit cells of the electrodialyzer in step (iii) comprise at least one unit cell comprising:
a first compartment delimited between a membrane permselective to monovalent anions and an anionic membrane;
a second compartment delimited between two anionic membranes;
a third compartment delimited between an anionic membrane and a membrane permselective to monovalent anions.

18. The process according to claim 1, wherein the three-compartment unit cells of the electrodialyzer in step (iii) comprise at least one unit cell comprising:
a first compartment delimited between a cationic membrane and an anionic membrane;
a second compartment delimited between two anionic membranes, and a third compartment delimited between an anionic membrane and a cationic membrane.

19. The process according to claim 17, wherein the first compartment is supplied with at least one basic salt, the second compartment is supplied with the partially demineralized and acidified milk protein composition obtained in step (ii), and the third compartment is supplied with at least one chloride salt of a monovalent cation.

20. The process according to claim 1, comprising a heat treatment step (viii), performed after step (ii) and before step (iii).

21. The process according to claim 1, wherein the milk protein composition in step (i) is whey.

22. The process according to claim 1, wherein the milk protein composition in step (i) is partially demineralized whey and has undergone at least one step selected from: an electrodialysis step, a nanofiltration step, a reverse osmosis step, an evaporation step, and a combination thereof.

23. A demineralized milk protein composition obtained by the process according to claim 1.

24. The process according to claim 14, wherein the first compartment is supplied with at least one acid salt, the second compartment is supplied with the milk protein composition of step (i), and the third compartment is supplied with at least one chloride salt of a monovalent cation.

25. The process according to claim 18, wherein the first compartment is supplied with at least one basic salt, the second compartment is supplied with the partially demineralized and acidified milk protein composition obtained in step (ii), and the third compartment is supplied with at least one chloride salt of a monovalent cation.
